(19) United States
(12) Patent Application Publication
(10) Pub. No.: US 2010/0129167 A1
(43) Pub. Date: May 27, 2010

(54) ROUGHING CUT EDGE INSERT WITH A FINISHING WIPER

(76) Inventor: Lewis Ray Morrison, Latrobe, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 12/275,383

(22) Filed: Nov. 21, 2008

(51) Int. Cl. B26D 3/00

(52) U.S. Cl. 407/114

(57) ABSTRACT

An indexable cutting insert having a body with a central axis extending therethrough and including two opposing surfaces interconnected by at least three sides. First and second sides intersect with one of the opposing surfaces at a primary corner to form a primary cutting edge having a corner radius. First and third sides intersect at a secondary corner. An intersection between an intermediate portion of the first side and the opposing surface forms a secondary cutting edge having an arcuate shape with a radius extending away from the central axis beyond a line between the primary corner and the secondary corner. An end of the secondary cutting edge is spaced from the end of the corner radius on the first side at a distance at least approximately one-eighth of a length of the line between the end of the corner radius on the first side and the secondary corner.

### BACKGROUND OF THE INVENTION

1. Field of the Invention

The present invention relates to an indexable cutting insert having a roughing cut edge combined with a finishing wiper edge. More particularly, the present invention relates to an indexable cutting insert having a roughing cut edge with a corner radius and a finishing cutting edge spaced from the roughing cut edge.

2. Description of Related Art

Typical metalworking turning operations are conducted with a lathe or similar tool using a cutting insert. First, machining is undertaken with one or more inserts suitable for rough cutting, which removes large amounts of material from a workpiece but leaves a relatively rough surface finish. Then, the roughly turned surface is machined by another insert configured to give the workpiece a finished cut. Such operations are time consuming and expensive since multiple cutting inserts must be used to machine a single workpiece to a desired shape and operations must be periodically halted in order to replace the inserts for different cutting operations.

The prior art includes several instances where the problem of providing an insert with the ability to make rough and finish cuts has been addressed. For example, U.S. Pat. No. 4,990,036 to Eklund et al. discloses a cutting insert having a main cutting edge extending around a corner radius for producing a roughing cut and a secondary cutting edge for producing a finishing cut. However, the secondary cutting edge is disposed very close to the main cutting edge. As a result, feed rates must be kept at a relatively low rate suitable for finishing cutting operations in order to ensure that the secondary cutting edge will properly engage the surface to provide a finishing cut. Thus, inserts such as the one disclosed by Eklund et al. limit the possible feed rate below what is suitable for normal rough cutting operations.

### SUMMARY OF THE INVENTION

Accordingly, there is a general need in the art for a single cutting insert that includes both a primary roughing cutting edge and a secondary finishing cutting edge to sequentially perform with a single insert roughing cutting and finishing cutting operations and that permits this sequential cutting operation to be conducted on a lathe or other machine at a higher feed rate suitable for roughing cutting operations while still achieving good results for both operations.

The present invention provides a cutting insert having both roughing cutting edges and finishing cutting edges that together are able to achieve favorable finish at a feed rate suitable for rough cutting operations. The roughing cutting edges and the finishing cutting edges are spaced along the sides of the insert at a distance sufficient to allow for a rough cutting feed rate to be used.

According to an embodiment of the present invention, an indexable cutting insert having a body with a central axis extending therethrough is provided. The body includes a first opposing surface and a second opposing surface spaced along the central axis of the body; and at least a first side, a second side, and a third side connecting the first and second opposing surfaces, the first side and the second side intersecting at a first primary corner, the first side and the third side intersecting at a first secondary corner. An intersection between the first opposing surface and the first primary corner forms a first primary cutting edge having a first corner radius, and the first corner radius terminates at an end on the first side and at an end on the second side. The first side intersects with the first opposing surface to form an intermediate portion between the first primary corner and the first secondary corner, the intermediate portion defining a first side secondary cutting edge having a convex shape extending beyond a line connecting the first primary corner and the first secondary corner. The closest distance between the first primary cutting edge and the first side secondary cutting edge is at least approximately one-eighth of the length of a line extending between the end of the first corner radius on the first side and the first secondary corner.

According to a further embodiment of the present invention, an assembly of a cutting insert and a workpiece is provided. The assembly includes an indexable cutting insert having a body with a central axis extending therethrough. The body includes a first opposing surface and a second opposing surface spaced along the central axis of the body; and at least a first side, a second side, and a third side connecting the first and second opposing surfaces, the first side and the second side intersecting at a first primary corner, the first side and the third side intersecting at a first secondary corner. An intersection between the first opposing surface and the first primary corner forms a first primary cutting edge having a first corner radius, and the first corner radius terminates at an end on the first side and at an end on the second side. The first side intersects with the first opposing surface to form an intermediate portion between the first primary corner and the first secondary corner, the intermediate portion defining a first side secondary cutting edge having a convex shape extending beyond a line connecting the first primary corner and the first secondary corner. The closest distance between the first primary cutting edge and the first side secondary cutting edge is at least approximately one-eighth of the length of a line extending between the end of the first corner radius on the first side and the first secondary corner. The assembly further includes a workpiece. The insert is positioned relative to the workpiece such that the central axis is generally perpendicular to the longitudinal axis and both the primary cutting edge and the secondary cutting edge engage the workpiece.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 is a top side perspective view of a cutting insert according to an embodiment of the present invention.

FIG. 2 is a top plan view of the cutting insert shown in FIG. 1.

FIG. 3 is a side view of the cutting insert shown in FIG. 1.

FIG. 4 is a cross-section view taken along line 4-4 shown in FIG. 2.

FIG. 5 is a cross-section view taken along line 5-5 shown in FIG. 2.

FIG. 6 is a cross-section view taken along line 6-6 shown in FIG. 2.

FIG. 7 is a more detailed view of the circled area shown in FIG. 4.

FIG. 8 is a view of an assembly according to an embodiment of the present invention.

### DESCRIPTION OF PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

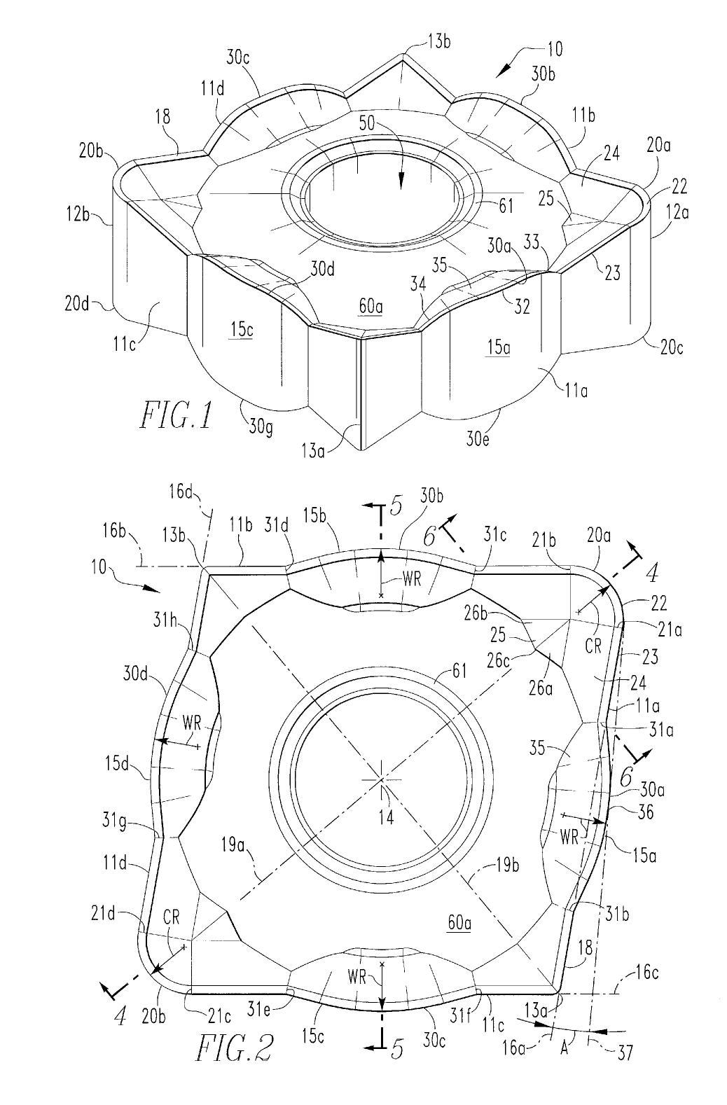

Referring to FIGS. 1-7, an indexable cutting insert according to an embodiment of the present invention is shown. A plurality of lines are provided in the drawings across the surfaces and features of the insert in order to connote the continuous curvature of the surfaces, which as a result, will not have distinct lines to highlight discontinuities. It is to be appreciated, though, that any curved surfaces shown and described herein may be replaced by multi-faceted surfaces. As shown in FIG. 1, the insert is of a generally polygonal shape and includes a body 10 made of wear-resistant material. The body 10 includes first opposing surface 60a and a second opposing surface 60b (shown in FIG. 4) spaced along a central axis 14 that extends through the body 10. The first 60a and second 60b opposing surfaces are interconnected by a first side 11a, a second side 11b, a third side 11e, and a fourth side 11d. As shown in FIGS. 1 and 2, the sides 11a, 11b, 11c, and 11d are parallel to the central axis 14 of the body 10. The first side 11a intersects with the second side 11b at a first primary corner 12a and with the third side at a first secondary corner 13a. The fourth side 11d intersects with the third side 11c at a second primary corner 12b and with the second side 11b at a second secondary corner 13b. A first primary cutting edge 20a is formed at an intersection between the first opposing surface 60a and the first primary corner 12a.

For the purposes of this discussion, an insert geometry identified as an 80° diamond, which is a rhombic configuration having two rounded 80° corners (primary corners 12a, 12b) and two 100° corners (secondary corners 13a, 13b), will be presented. As shown in FIGS. 1 and 2, the first secondary corner 13a and the second secondary corner 13b are sharp 100° corners. It is to be appreciated that the first secondary corner 13a and the second secondary corner 13b may be of any suitable configuration, including rounded or beveled corners and could additionally be provided with cutting edges. It is also to be appreciated that the configuration of the body 10 is not limited to an 80° diamond and that other geometric shapes may be substituted. Among the shapes may be other rhombic configurations such as a 55° diamond, a 50° diamond, a 35° diamond, a pentagon, a triangle, or a trigon.

The body 10 of the insert should be manufactured of a wear-resistant material. Refractory coated cemented carbide materials, such as KC9140, KC9240, KC8050, P25-40, M25-40, and K25-40 may be used. Ceramic materials may also be used.

KC9140 is a trademark of Kennametal Inc., representing a ceramic-coated carbide grade of a TiC/Al₂O₃/TiN coating over a substrate. KC9240 is a trademark of Kennametal Inc., representing a ceramic-coated carbide grade of a TiC/Al₂O₃/TiN coating over a substrate. KC8050 is a trademark of Kennametal Inc., representing a multilayered coated carbide grade having a TiCN/Al₂O₃/TiN coating over a substrate. P25-40 is a trademark of Kennametal Inc., representing a multilayered coated carbide grade having a TiCN/Al₂O₃/TiN coating over a substrate. M25-40 is a trademark of Kennametal Inc., representing a multilayered coated carbide grade having a TiCN/Al₂O₃/TiN coating over a substrate. K25-40 is a trademark of Kennametal Inc., representing a multilayered coated carbide grade having a TiCN/Al₂O₃/TiN coating over a substrate.

Returning to FIGS. 1 and 2, the first primary cutting edge 20a has a first corner radius CR. The first corner radius CR terminates at an end 21a on the first side 11a and at an end 21b on the second side 11b. Further, a second primary cutting edge 20b is formed at an intersection between the first opposing surface 60a and the second primary corner 12b. The second primary cutting edge 20b has a second corner radius CR terminating at an end 21c on the third side 11c and at an end 21d on the fourth side 11d. The first corner radius CR and the second corner radius CR are equal and according to the current embodiment of the invention are approximately 1/16 in. The first primary cutting edge 20a and the second primary cutting edge 20b are roughing cutting edges according to the current embodiment of the invention suitable for high volume cutting/machining of a workpiece 100 (shown in FIG. 8), though it is to be appreciated that the primary cutting edge 20a and the second primary cutting edge 20b may be of any type known to those of ordinary skill in the art.

An intermediate portion 15a is formed at an intersection between the first side 11a and the first opposing surface 60a between the first primary corner 12a and the first secondary corner 13a. The intermediate portion 15a defines a first side secondary cutting edge 30a. As shown in FIGS. 1 and 2, the first side secondary cutting edge 30a has an arcuate shape with a radius WR extending in a direction away from the central axis 14 of the body 10 beyond a line 16a extending between the end 21a of the first corner radius CR on the first side 11a and the first secondary corner 13a. The first side secondary cutting edge 30a has a first end 31a and a second end 31b with the first end 31a being disposed between the end 21a of the first corner radius CR on the first side 11a and the second end 31b. The first end 31a of the first side secondary cutting edge 30a is spaced from the end 21a of the first corner radius CR on the first side 11a by a distance of at least approximately one-eighth (⅛) and less than approximately one-quarter (¼) of the length of the line 16a extending between the end 21a of the first corner radius CR on the first side 11a and the first secondary corner 13a.

According to the current embodiment of the invention, the radius of the first side secondary cutting edge 30a is approximately 9/32 in. The first side secondary cutting edge 30a is a finishing edge, particularly a wiper edge, according to the current embodiment of the invention suitable for precision cutting of the workpiece 100, though it is to be appreciated that the first side secondary cutting edge 30a may be of any type known to those of ordinary skill in the art.

As shown in FIGS. 1 and 2, in like manner to the first side secondary cutting edge 30a, second side, third side, and fourth side secondary cutting edges 30b, 30c, 30d are formed at intersections between the first opposing surface 60a and intermediate portions 15b, 15c, 15d of the second 11b, third 11c, and fourth 11d sides, respectively. Each of these secondary cutting edges 30b, 30c, and 30d has an arcuate shape with the radius WR extending in a direction away from the central axis 14 of the body 10. The radius WR of the second side secondary cutting edge 30b extends past a line 16b extending between the end 21b of the corner radius CR on the second side 11b and the second secondary corner 13b. The radius WR of the third side secondary cutting edge 30c extends past a line 16c extending between the end 21c of the second corner radius CR on the third side 11c and the secondary corner 13a. The radius WR of the fourth side secondary cutting edge 30d extends past a line 16d extending between the end 21d of the second corner radius CR on the fourth side 11d and the second secondary corner 13b. Each of the second side 30b, third side 30c and fourth side 30d secondary cutting edges have a first end 31c, 31e, 31g and a second end 31d, 31f, 31h with the first end 31c, 31e, 31g being disposed between the second end 31d, 31f, 31h and the corresponding end 21b, 21c, 21d of the first corner radius CR or the second corner radius CR. The first end 31c of the second side secondary cutting edge 30b is spaced from the end 21b of the first corner radius CR on the second side 11b by distance of at least approximately one-eighth (⅛) and less than approximately one-quarter (¼) of the length of the line 16b extending between the end 21b of the first corner radius CR on the second side 11b and the second secondary corner 13b. The first end 31e of the third side secondary cutting edge 30c is spaced from the end 21c of the second corner radius CR on the third side 11c by a distance of at least approximately one-eighth (⅛) and less than approximately one-quarter (¼) of the length of the line 16c extending between the end 21c of the second corner radius CR on the third side 11c and the first secondary corner 13a. The first end 31g of the fourth side secondary cutting edge 30d is spaced from the end 21d of the second corner radius CR on the fourth side 11b by a distance of at least approximately one-eighth (⅛) and less than approximately one-quarter (¼) of the length of the line 16d extending between the end 21d of the second corner radius CR on the fourth side 11d and the second secondary corner 13b. It is to be appreciated that the second side 30b, third side 30c, and fourth side 30d secondary cutting edges are also formed as finishing edges, particularly wiper edges, as is the first side secondary cutting edge 30a, discussed above. It is also to be appreciated that the radiuses WR of each of the first side 30a, second side 30b, third side 30c, and fourth side 30d secondary cutting edges are equal.

As shown in FIGS. 1 and 2, the body 10 further includes a peripheral land 18 extending about the entire periphery or perimeter of the body 10. It is to be appreciated that the land 18 is not needed to achieve the benefits of the current embodiment of the invention and may be eliminated in favor of a honed radius edge.

With reference to FIGS. 2-5, the body 10 is symmetric about a plane 19a extending between the first primary corner 12a and the second primary corner 12b as well as about a plane 19b extending between the first secondary corner 13a and the second secondary corner 13b. Accordingly, the first side 11a, second side 11b, third side 11c, and fourth side 11d have identical dimensions and configurations. Likewise, the primary cutting edges 20a, 20b, and secondary cutting edges 30a, 30b, 30c, 30d are identical. As such, the insert may be used either in a left-handed or a right-handed manner.

Further, the body 10 is also symmetric about a central plane 17, which is perpendicular to the central axis 14 and midway through the body 10. Accordingly, a third primary cutting edge 20c and a fourth primary cutting edge 20d are formed by intersections of the first side 11a, the second side 11b, the third side 11e, the fourth side 11d, and the second opposing surface 60b, which are identical to the primary cutting edge 20a and the second primary cutting edge 20b. Likewise, fifth 30e (shown in FIGS. 1 and 3), sixth 30f (shown in FIG. 5), seventh 30g (shown in FIGS. 1 and 5), and eighth (not shown) secondary cutting edges are formed by intersections between the intermediate portions 15a, 15b, 15c, 15d of the sides 11a, 11b, 11e, 11d, and the second opposing surface 60b and are identical to the first side 30a, second side 30b, third side 30c, and fourth side 30d secondary cutting edges. As such, the insert is also invertible.

Since the size and configuration of each of the sides 11a, 11b, 11e, 11d is identical and the size and configuration of the various cutting edges described above are also identical as to each of the sides 11a, 11b, 11e, 11d, further details of the current embodiment of the invention as to both the primary cutting edges and the secondary cutting edges will be restricted to a discussion regarding the first opposing surface 60a, first side 11a, the first primary cutting edge 20a and the first side secondary cutting edge 30a with the understanding that corresponding features of the current embodiment of the invention will be identical.

With reference to FIGS. 1-3, the first primary cutting edge 20a includes a flat segment 22 extending around the first corner radius CR from the end 21a of the first corner radius CR on the first side 11a to the end 21b of the first corner radius CR on the second side 11b. As shown in FIG. 3, the flat segment 22 of the first primary cutting edge 20a is disposed at a height H above the central plane 17 of the body 10. The first primary cutting edge 20a also includes a first side segment 23 extending from the end 21a of the first corner radius CR on the first side 11a to the first end 31a of the first side secondary cutting edge 30a. The first side segment 23 of the first primary cutting edge 20a tapers downward toward the central plane 17 of the body 10 with a linear taper.

As shown in FIG. 3, the first side secondary cutting edge 30a includes a central flat segment 32 that is disposed at height H above the central plane 17 of the body 10. The height of the central flat segment 32 of the first side secondary cutting edge 30a and the height of the flat segment 22 of the first primary cutting edge 20a are equal. The first side secondary cutting edge 30a also includes a first tapered segment 33, which tapers upward from the central plane 17 of the body 10 and extends from the first end 31a of the first side secondary cutting edge 30a to the central flat segment 32 and a second tapered segment 34, which tapers downward toward the central plane 17 of the body 10 and extends from the central flat segment 32 to the second end 31b of the first side secondary cutting edge 30a. The first 33 and second 34 tapered segments of the first side secondary cutting edge 30a have arcuate tapers. The first side segment 23 of the first primary cutting edge 20a serves to provide a positive rake. It is to be appreciated that the first side segment 23 of the first primary cutting edge 20a and the first tapered segment 33 of the first side secondary cutting edge 30a may be replaced with a level segment extending between the end 21a of the first corner radius CR on the first side 11a and the central flat segment 32 of the first side secondary cutting edge 30a.

As shown in FIGS. 1 and 2, the intermediate portion 15a of the first side 11a has an arcuate shape extending outward from a plane that contains line 16a and extends between the end 21a of the first corner radius CR on the first side 11a and the secondary corner 13a so as to conform to the curvature of the first side secondary cutting edge 30a. All other portions of the first side 11a extend along the plane.

As shown in FIGS. 1 and 2, the body 10 includes a primary cutting rake face 24 extending upwardly from the first opposing surface 60a to the first primary cutting edge 20a. The primary cutting rake face 24 serves to convey chips formed during a cutting process of the workpiece 100 away from the first primary cutting edge 20a as it cuts the workpiece 100. To that end, the primary cutting rake face 24 includes a chip control feature 25 to channel chips away from the first primary cutting edge 20a. The chip control feature 25 extends from the first opposing surface 60a opposite to the corner radius CR and includes a first triangular face 26a and a second triangular face 26b. The first 26a and second 26b triangular faces are inclined with respect to the primary cutting rake face 24 and have adjoining sides so as to form a central ridge 26c such that the chip control feature 25 has a pyramidal shape.

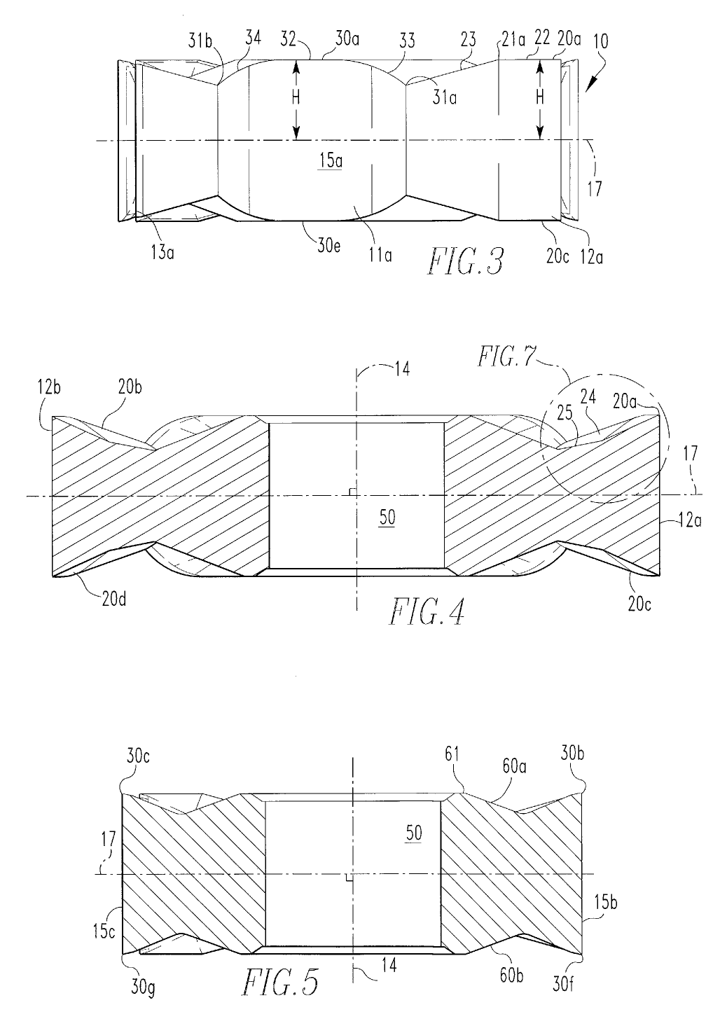

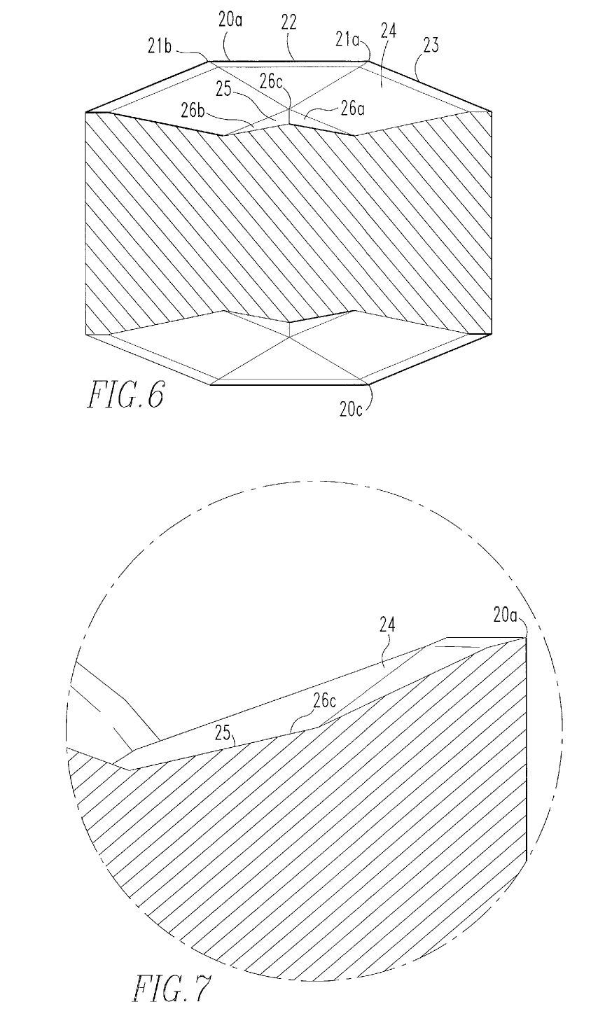

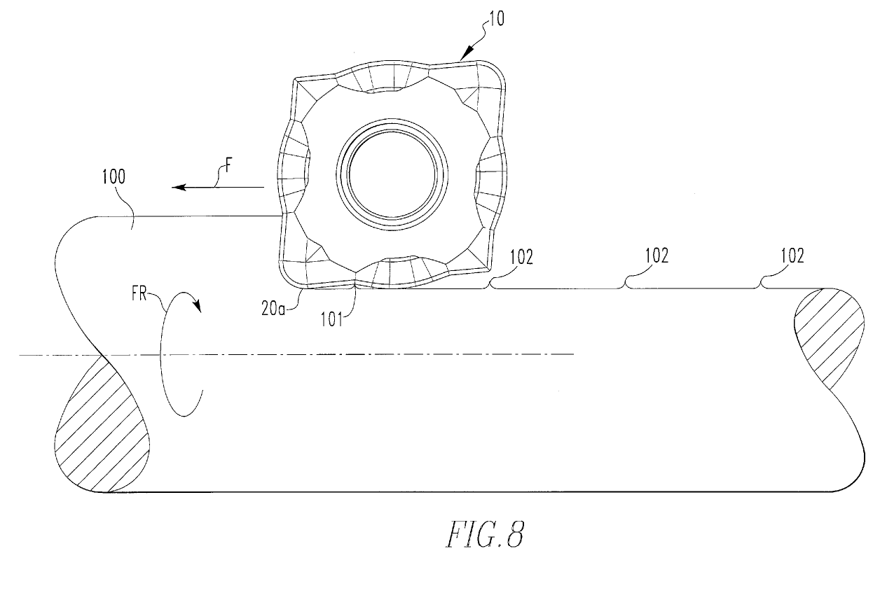

More particularly, as shown in FIGS. 6 and 7, the first 26a and second 26b triangular faces are inclined upward from the adjacent portions of the primary cutting rake face 24 and meet at the central ridge 26c. The primary cutting rake face 24 extends upward from the first opposing surface 60a to the primary cutting edge 20a with respect to the central plane 17. Thus the chip control feature 25 forms channels between the first 26a and second 26b triangular faces and the primary cutting rake face 24 to facilitate the movement of chips away from the primary cutting edge 20a. The height of the chip control feature 25 is approximately 0.009 in. as measured from the intersection between the primary cutting rake face 24 and the first opposing surface 60a to the central ridge 26c. The length of the chip control feature 25 is approximately 0.055 in. as measured along the length of the central ridge 26c from the first opposing surface 60a to the primary cutting rake face 24. It is to be appreciated that the chip control feature 25 may be formed as any configuration known by those of ordinary skill in the art to be suitable for channeling chips away from a cutting edge during a cutting or machining operation, including a curved configuration or a plurality of fingers along the cutting rake face.

As shown in FIGS. 1, 2, and 5, a first side secondary cutting rake face 35 extends upwardly from the first opposing surface 60a to the first side secondary cutting edge 30a for conveying chips away from the first side secondary cutting edge 30a during a cutting operation.

As shown in FIGS. 1, 4 and 5, the first opposing surface 60a has a convex dome shape and the body 10 includes a bore 50 extending from the first opposing surface 60a to the second opposing surface 60b co-extensive with the central axis 14 of the body 10. The convex dome shape of the first opposing surface 60a includes a flat portion 61 in the central area of the first opposing surface 60a that forms the periphery of the bore 50. The bore 50 accepts a bolt (not shown) for fastening the insert to a toolholder. The insert fits within a standard toolholder that may be modified for clearance customized to the particular insert. The first opposing surface 60a is given a dome shape in order to provide sufficient thickness to the insert for fastening. The first opposing surface 60a is provided with the flat portion 61 in order to allow for adequate engagement between the insert and head of the bolt. Further, the bore 50 may include beveled segments for receiving the head of the bolt. Alternatively, the insert may be clamped within the toolholder, thereby eliminating need for the bore 50.

With reference to FIG. 2, an angle A of approximately 5° is formed between the line 16a extending between the end 21a of the first corner radius CR on the first side 11a and the secondary corner 13a and a line 37 extending between the end 21a of the first corner radius CR on the first side ha and the first side secondary cutting edge 30a at an apex point 36. The apex point 36 being the point of the first side secondary cutting edge 30a disposed the farthest distance beyond the line 16a. Thus, as is shown in FIG. 8, the insert is oriented relative to the surface of the workpiece 100 at an angle of 5° to ensure that both the first primary cutting edge 20a and the first side secondary cutting edge 30a both engage the workpiece 100. Further, the insert may also be oriented at a 5° angle to the vertical with respect to the workpiece 100 to provide a positive cutting angle.

With reference to FIG. 8, an assembly according to an embodiment of the present invention is shown. The assembly includes the insert body 10 and the workpiece 100, which may be made from a variety of materials. As shown in FIG. 8, the insert is used in a lathe operation for cutting the workpiece 100 to a desired shape. The insert body 10 is fastened or clamped to a lathe (not shown) and positioned relative to the workpiece 100 such that the central axis 14 of the insert body 10 is generally perpendicular to the longitudinal axis of the workpiece 100 and both the first primary cutting edge 20a and the first side secondary cutting edge 30a engage the workpiece 100. The insert body 10 is moved by the lathe relative to the workpiece 100 in a direction F that is substantially parallel to the longitudinal axis of the workpiece 100. Further, the lathe is activated to rotate the workpiece 100 with respect to the insert body 10 in a direction feed rotation FR. It is to be appreciated that though the indexable cutting insert has been described as being usable in a lathe operation, the insert according to the current invention may be adapted for use in other cutting applications

The distance that the insert body 10 is moved relative to the workpiece 100 in the feed direction F per revolution of the workpiece 100 in the direction of feed rotation FR is defined as the feed rate. A portion of the workpiece 100 is engaged by the first primary cutting edge 20a to make a rough or high-volume cut of the portion during a single revolution or pass. This rough cut leaves a scallop 101 in the workpiece 100. The distance between adjacent scallops 101 created by the first primary cutting edge 20a in successive revolutions or passes corresponds to the feed rate of the insert body 10 relative to the workpiece 100. The height of the scallops 101 corresponds to the length of cut of the primary cutting edge 20a. According to the current embodiment of the invention, the length of cut of the first primary cutting edge 20a is at least one half of an inscribed circumference (IC) of the insert body 10 in order to ensure that the workpiece 100 is engaged by both the first primary cutting edge 20a and the first side secondary cutting edge 30a during a cutting operation. The inscribed circumference (IC) of the insert body 10 is between approximately ⅜ and ¾ in., according to the current embodiment of the invention. The feed rate of the insert body 10 is kept relatively low during a cutting operation in comparison to typical rough cutting operations in order to account for the higher than normal length of cut and attendant high volume of cut material to be removed from the area of the first primary cutting edge 20a.

During a subsequent revolution or pass of the workpiece 100 with respect to the insert body 10, the same portion of the workpiece 100 having previously been cut by the first primary cutting edge 20a, leaving scallop 101, is engaged by the first side secondary cutting edge 30a to make a finishing cut of the portion. This finishing cut removes the scallop 101 left during the rough cut of the portion and creates scallops 102, spaced further apart. As shown in FIG. 8, the height of scallops 102 relative to the scallop 101 is exaggerated for purposes of illustration. In actuality, the height of the scallops 102 is negligible and the presence of such scallops 102 cannot be determined by visual inspection of the workpiece 100.

As shown in FIG. 8, the insert 10 is capable of cutting the workpiece 100 at a feed rate such that the portion of the workpiece 100 cut by the first primary cutting edge 20a during a revolution or cutting pass of the workpiece 100 will be cut by the first side secondary cutting edge 30a during the next revolution or cutting pass of the workpiece 100. Accordingly, the feed rate of the insert 10 is at least 0.01 in. per revolution of the workpiece 100 but no more than 0.03 in. per revolution of the workpiece 100. Because the first side secondary cutting edge 30a is spaced from the first primary cutting edge 20a, as discussed above, the workpiece 100 may be cut at a higher feed rate with respect to typical finishing operations since the first side secondary cutting edge 30a will not engage a portion of the workpiece during rough cutting. Thus, a machining operation can be performed at a feed rate appropriate for rough cutting operations while still achieving the benefits of performing a rough cutting and a finishing cutting operation in a single operation of the lathe using a single cutting insert 10.

With reference to FIG. 8, in operation the indexable cutting insert 10 is provided along with a workpiece 100. A feed rate of the workpiece 100 with respect to the first primary cutting edge 20a of the insert is selected such that a portion of the workpiece 100 cut by the first primary cutting edge 20a during a cutting pass will be cut by the first side secondary cutting edge 30a of the insert during a subsequent cutting pass. Ideally, the first side secondary cutting edge 30a will engage a portion of the workpiece 100 cut by the first primary cutting edge 20a on the next revolution or cutting pass of the workpiece 100, though it is to be appreciated that a number of revolutions or cutting passes of the workpiece 100, for instance 2-3 revolutions, may occur between the rough cut and the finishing cut. The workpiece 100 is then cut to a desired shape in a plurality of cutting passes with the primary cutting edge 20a and the first side secondary cutting edge 30a at the selected feed rate. Accordingly, the feed rate of the insert 10 is at least 0.01 in. per revolution of the workpiece 100 but no more than 0.03 in. per revolution of the workpiece 100.

While several embodiments of an indexable cutting insert were described in the foregoing detailed description, those skilled in the art may make modifications and alterations to these embodiments without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are embraced within their scope.

What is claimed is:

1. An indexable cutting insert comprised of a body having a central axis extending therethrough, wherein the body comprises:
a first opposing surface and a second opposing surface spaced along the central axis of the body; and
at least a first side, a second side, and a third side connecting the first and second opposing surfaces, the first side and the second side intersecting at a first primary corner, the first side and the third side intersecting at a first secondary corner,
wherein an intersection between the first opposing surface and the first primary corner forms a first primary cutting edge having a first corner radius, and the first corner radius terminates at an end on the first side and at an end on the second side,
wherein the first side intersects with the first opposing surface to form an intermediate portion between the first primary corner and the first secondary corner, the intermediate portion defining a first side secondary cutting edge having a convex shape extending beyond a line connecting the first primary corner and the first secondary corner, wherein the closest distance between the first primary cutting edge and the first side secondary cutting edge is at least approximately one-eighth of the length of a line extending between the end of the first corner radius on the first side and the first secondary corner.

2. The indexable cutting insert according to claim 1,
wherein the closest distance between the first primary cutting edge and the first side secondary cutting edge is less than approximately one-quarter of the length of the line extending between the end of the first corner radius on the first side and the first secondary corner.

3. The indexable cutting insert according to claim 1,
wherein the body further comprises a fourth side connecting the first and second opposing surfaces, the third side and the fourth side intersecting at a second primary corner, the second side and the fourth side intersecting at a second secondary corner, and
wherein an intersection between the first opposing surface and the second primary corner forms a second primary cutting edge having a second corner radius and the second corner radius terminates at an end on the third side and at an end on the fourth side.

4. The indexable cutting insert according to claim 3,
wherein the second side intersects with the first opposing surface to form an intermediate portion between the first primary corner and the second secondary corner, the intermediate portion defining a second side secondary cutting edge having a convex shape extending beyond a line connecting the first primary corner and the second secondary corner, wherein the closest distance between the first primary cutting edge and the second side secondary cutting edge is at least approximately one-eighth of the length of a line extending between the end of the first corner radius on the second side and the second secondary corner.

5. The indexable cutting insert according to claim 3,
wherein the third side intersects with the first opposing surface to form an intermediate portion between the second primary corner and the second secondary corner, the intermediate portion defining a third side secondary cutting edge having a convex shape extending beyond a line connecting the second primary corner and the second secondary corner, wherein the closest distance between the second primary cutting edge and the third side secondary cutting edge is at least approximately one-eighth of the length of a line extending between the end of the second corner radius on the third side and the second secondary corner.

6. The indexable cutting insert according to claim 3,
wherein the fourth first side intersects with the first opposing surface to form an intermediate portion between the second primary corner and the secondary corner, the intermediate portion defining a fourth side secondary cutting edge having a convex shape extending beyond a line connecting the second primary corner and the first secondary corner, wherein the closest distance between the second primary cutting edge and the fourth side secondary cutting edge is at least approximately one-eighth of the length of a line extending between the end of the second corner radius on the fourth side and the first secondary corner.

7. The indexable cutting insert according to claim 3, wherein the body has an 80° diamond shape.

8. The indexable cutting insert according to claim 3, wherein the first corner radius and the second corner radius are equal and the body is symmetric about a plane extending between the first secondary corner and the second secondary corner.

9. The indexable cutting insert according to claim 1, wherein the body has a central plane perpendicular to the central axis and midway through the body and wherein the body is symmetric about the central plane such that the insert is invertible.

10. The indexable cutting insert according to claim 9,
wherein the first primary cutting edge includes a flat segment extending around the first corner radius from the end of the first corner radius on the first side to the end of the first corner radius on the second side, the flat segment of the first primary cutting edge disposed at a height above the central plane of the body, and a first side segment extending from the end of the first corner radius on the first side to a first end of the first side secondary cutting edge, the first side segment of the first primary cutting edge tapering downward toward the central plane of the body, and
wherein the first side secondary cutting edge includes a central flat segment, the central flat segment of the first side secondary cutting edge disposed at a height above the central plane of the body equal to the height of the flat segment of the first primary cutting edge, a first tapered segment tapering upward from the central plane of the body and extending from the first end of the first side secondary cutting edge to the central flat segment, and a second tapered segment tapering downward toward the central plane of the body and extending from the central flat segment to a second end of the first side secondary cutting edge.

11. The indexable cutting insert according to claim 10, wherein the first side segment of the first primary cutting edge has a linear downward taper.

12. The indexable cutting insert according to claim 10, wherein the first and second tapered segments have arcuate tapers.

13. The indexable cutting insert according to claim 1, wherein the intermediate portion of the first side has an arcuate shape extending outward from a plane extending between the end of the first corner radius on the first side and the first secondary corner and all other portions of the first side extend along the plane extending between the end of the first corner radius on the first side and the first secondary corner.

14. The indexable cutting insert according to claim 3, wherein the first, second, third, and fourth sides are parallel to the central axis of the body.

15. The indexable cutting insert according to claim 1, wherein the body further comprises a primary cutting rake face extending upwardly from the first opposing surface to the first primary cutting edge.

16. The indexable cutting insert according to claim 15, wherein the primary cutting rake face includes a chip control feature extending upwardly from the first opposing surface opposite to the first corner radius.

17. The indexable cutting insert according to claim 16, wherein the chip control feature includes a first triangular face and a second triangular face, the first and second triangular faces being inclined with respect to the primary cutting rake face and having adjoining sides forming a central ridge such that the chip control feature has a pyramidal shape.

18. The indexable cutting insert according to claim 1, wherein the body further comprises a first side secondary cutting rake face extending upwardly from the first opposing surface to the first side secondary cutting edge.

19. The indexable cutting insert according to claim 1, wherein the first primary cutting edge is a roughing cutting edge.

20. The indexable cutting insert according to claim 1, wherein the first side secondary cutting edge is a finishing cutting edge.

21. The indexable cutting insert according to claim 20, wherein the finishing cutting edge is a wiper cutting edge.

22. The indexable cutting insert according to claim 1, wherein the body is configured such that a length of cut of the first primary cutting edge is at least one half of an inscribed circumference of the insert.

23. The indexable cutting insert according to claim 1, wherein the body further comprises a land extending about an entire periphery of the body.

24. The indexable cutting insert according to claim 1, wherein the insert is made from a wear resistant material.

25. The indexable cutting insert according to claim 24, wherein the wear resistant material comprises cemented carbide material.

26. The indexable cutting insert according to claim 1, wherein the first opposing surface has a convex dome shape.

27. The indexable cutting insert according claim 1, wherein the body further comprises a bore extending from the first opposing surface to the second opposing surface, the bore being co-extensive with the central axis of the body.

28. The indexable cutting insert according to claim 1, wherein an angle formed between the line extending between the end of the first corner radius on the first side and the first secondary corner and a line extending between the end of the first corner radius on the first side and the first side secondary cutting edge at an apex point is approximately 5°.

29. The indexable cutting insert according to claim 1, wherein the first corner radius is between approximately 1/32 and 1/16 in.

30. The indexable cutting insert according to claim 1, wherein a radius of the first side secondary cutting edge is approximately 9/32 in.

31. The indexable cutting insert according to claim 1, wherein an inscribed circumference of the insert is between approximately ⅜ and ¾ in.

32. An assembly, comprising:
an indexable cutting insert comprised of a body having a central axis extending therethrough, wherein the body comprises:
a first opposing surface and a second opposing surface spaced along the central axis of the body; and
at least a first side, a second side and a third side connecting the first and second opposing surfaces, the first side and the second side intersecting at a first primary corner, the first side and the third side intersecting at a first secondary corner,
wherein an intersection between the first opposing surface and the first primary corner forms a first primary cutting edge having a first corner radius, and the first corner radius terminates at an end on the first side and at an end on the second side,
wherein the first side intersects with the first opposing surface to form an intermediate portion between the first primary corner and the first secondary corner, the intermediate portion defining a first side secondary cutting edge having a convex shape extending beyond a line connecting the first primary corner and the first secondary corner, wherein the closest distance between the first primary cutting edge and the first side secondary cutting edge is at least approximately one-eighth of the length of a line extending between the end of the first corner radius on the first side and the first secondary corner; and
a workpiece rotatable about a longitudinal axis thereof,
wherein the insert body is positioned relative to the workpiece such that the central axis is generally perpendicular to the longitudinal axis and both the first primary cutting edge and the secondary cutting edge engage the workpiece.

33. The assembly according to claim 32, wherein the indexable cutting insert is movable relative to the workpiece in a direction substantially parallel to the longitudinal axis of the workpiece such that a portion of the workpiece engaged by the first primary cutting edge during a revolution of the workpiece is engaged by the first side secondary cutting edge during a subsequent revolution of the workpiece.

34. The assembly according to claim 33, wherein the subsequent revolution of the workpiece is the next revolution of the workpiece.

35. The assembly according to claim 34, wherein the indexable cutting insert is movable relative to the workpiece at a feed rate of between 0.01 and 0.03 in. per revolution of the workpiece.
